(19) United States
(12) Patent Application Publication
(10) Pub. No.: US 2006/0065581 A1
(43) Pub. Date: Mar. 30, 2006

(54) Electromagnetic valve unit and engine cover unit

(75) Inventors: Shinji Kazaoka, Kariya-shi (JP); Hideaki Takahashi, Okazaki-shi (JP)

Correspondence Address: REED SMITH LLP;Suite 1400, 3110 Fairview Park Drive, Falls Church, VA, 22042, US

(73) Assignee: Aisin Seiki Kabushiki Kaisha

(21) Appl. No.: 11/234,244

(22) Filed: Sep. 26, 2005

(30) Foreign Application Priority Data
Sep. 27, 2004 (JP) 2004-279928
Sep. 9, 2005 (JP) 2005-262020

(51) Int. Cl. B01D 35/14

(52) U.S. Cl. 210/110; 210/109; 210/435; 210/418; 184/6.24

(57) ABSTRACT

An electromagnetic valve unit comprises a first electromagnetic valve provided at a cover, which is positioned at one end portion of an engine, for controlling an amount of hydraulic oil supplied from a hydraulic pressure source to a first hydraulic mechanism, a second electromagnetic valve provided at the cover so as to be next to the first electromagnetic valve for controlling an amount of hydraulic oil supplied from the hydraulic pressure source to a second hydraulic mechanism and an oil filter provided between the first electromagnetic valve and the second electromagnetic valve and connected to each of the first and the second electromagnetic valves in order to filter the hydraulic oil supplied to each of the first and the second electromagnetic valves.

### CROSS REFERENCE TO RELATED APPLICATIONS

This application is based on and claims priority under 35 U.S.C. § 119 to Japanese Patent Application 2004-279928, filed on Sep. 27, 2004 and Japanese Patent Application 2005-262020, filed on Sep. 9, 2005, the entire content of which is incorporated herein by reference.

### FIELD OF THE INVENTION

This invention generally relates to an alignment structure for an electromagnetic valve. More particularly, this invention relates to an alignment for an electromagnetic valve in which at least two electromagnetic valves are aligned at a hydraulic circuit.

### BACKGROUND

A known alignment structure of an electromagnetic valve disclosed in, for example, JP2001-355415A, a variable valve timing control device (hereinafter referred to as a VVT) is mounted on each end of an intake camshaft and an exhaust camshaft in a cylinder head and each VVT is driven by a solenoid valve. Further, oil paths are connected to solenoid valves from a main fluid path through a common oil filter, the solenoid valves are respectively mounted outside of the cylinder head in the vicinity of the end portion of the corresponding camshaft.

In such known alignment structure, because each of the VVT solenoid valves is positioned on each end of the cylinder head, a long fluid path needs to be formed, and this configuration requires a more space and increases costs of the electromagnetic valve. Further, because an oil filter for the solenoid valve is mounted within a cam chamber so as to be detachable, in each case the oil filter is removed, the head cover also needs to be removed, as a result, maintenance efficiency has been impaired.

Thus, a need exists for the alignment structure of an electromagnetic valve to improve the alignment of the electromagnetic valves so that an electromagnetic valve unit becomes compact, and to improve the maintenance efficiency of the oil filter.

### SUMMARY OF THE INVENTION

According to an aspect of the present invention, an electromagnetic valve unit comprises a first electromagnetic valve provided at a cover, which is positioned at one end portion of an engine, for controlling an amount of hydraulic oil supplied from a hydraulic pressure source to a first hydraulic mechanism, a second electromagnetic valve provided at the cover so as to be next to the first electromagnetic valve for controlling an amount of hydraulic oil supplied from the hydraulic pressure source to a second hydraulic mechanism and an oil filter provided between the first electromagnetic valve and the second electromagnetic valve and connected to each of the first and the second electromagnetic valves in order to filter the hydraulic oil supplied to each of the first and the second electromagnetic valves.

According to another aspect of the present invention, an engine cover unit comprises a cover provided at an end portion of an engine, a first electromagnetic valve provided at the cover for controlling an amount of hydraulic oil supplied from a hydraulic pressure source to a first hydraulic mechanism, a second electromagnetic valve provided next to the first electromagnetic valve for controlling an amount of hydraulic oil supplied from the hydraulic pressure source to a second hydraulic mechanism, and an oil filter provided between the first electromagnetic valve and the second electromagnetic valve and connected to each of the first and the second electromagnetic valves in order to filter the hydraulic oil supplied to each of the first and the second electromagnetic valves.

### BRIEF DESCRIPTION OF THE DRAWINGS

The foregoing and additional features and characteristics of the present invention will become more apparent from the following detailed description considered with reference to the accompanying drawings, wherein:

FIG. 1 illustrates a front view indicating a timing chain cover 100 according to a first embodiment of the present invention;

FIG. 2 illustrates a left side view of the timing chain cover 100 shown in FIG. 1;

FIG. 3 illustrates a cross section along a III-III line in FIG. 1;

FIG. 4 illustrates a cross section along a IV-IV line in FIG. 2;

FIG. 5 illustrates a cross section of an essential part indicating a timing chain cover 200 according to a second embodiment of the present invention.

### DETAILED DESCRIPTION

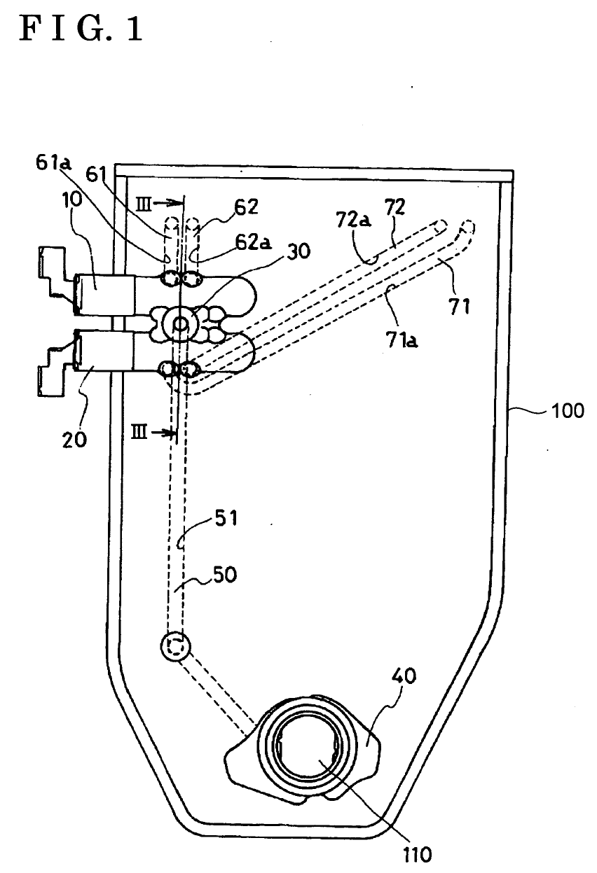

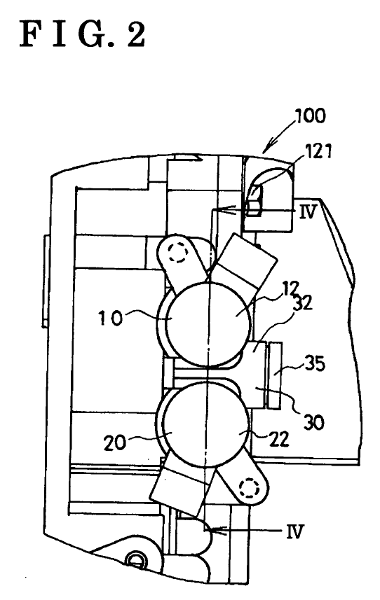

Embodiments of the present invention will be explained with reference to drawing figures. A first embodiment of the present invention is shown in FIGS. 1, 2, 3 and 4. FIGS. 1 and 2 illustrate a timing chain cover 100 (cover), and the timing chain cover 100 includes a first electromagnetic valve 10 and a second electromagnetic valve 20. Specifically, the first electromagnetic valve 10 controls hydraulic oil supplied to an intake valve phase changing means (intake valve opening/closing timing control device serving as a first hydraulic mechanism), which changes a rotation phase of an intake valve camshaft (not shown), and the second electromagnetic valve 20 controls hydraulic oil supplied to an exhaust valve phase changing means (exhaust valve opening/closing timing control device serving as a second hydraulic mechanism), which changes a rotation phase of an exhaust valve camshaft (not shown).

The intake valve phase changing means is comprised of a driven rotor, which is rotatably fixed to the intake valve camshaft so as to be integrated therewith, and a driving rotor, which is positioned rotatable relative to the driven rotor, and the exhaust valve phase changing means is comprised of a driven rotor, which is rotatably fixed to the exhaust valve camshaft so as to be integrated therewith, and a driving rotor, which is positioned rotatable relative to the driven rotor.

By use of the intake valve phase changing means and the exhaust valve phase changing means, the hydraulic oil supplied to an advanced angle chamber and a retarded angle chamber, which are formed between the driven rotor and the driving rotor, is controlled in order to rotate the driven rotor relative to the driving rotor in an advanced angle side or a retarded angle side.

The timing chain cover 100 further includes an oil filter 30, which is provided between the first electromagnetic valve 10 and the second electromagnetic valve 20 so as to connect the first electromagnetic valve 10 to the second electromagnetic valve 20 in order to filter the hydraulic oil supplied to the first electromagnetic valve 10 and the second electromagnetic valve 20. An electromagnetic valve unit according to the present invention is comprised of the first electromagnetic valve 10, the second electromagnetic valve 20 and the oil filter 30, and an engine cover unit according to the present invention is comprised of the electromagnetic valve unit and the timing chain cover 100.

Further, the timing chain cover 100 includes an oil pump 40 serving as a hydraulic pressure source. The oil pump 40 is actuated by a crank shaft 110. A fluid path 50 is formed between a discharge portion (not shown) of the oil pump 40 and the oil filter 30. On the timing chain cover 100, fluid paths 61, 62, 71 and 72 are formed.

Specifically, the fluid path 61 is formed between the first electromagnetic valve 10 and the advanced angle chamber of the intake valve phase changing means, and the fluid path 62 is formed between the first electromagnetic valve 10 and the retarded angle chamber of the intake valve phase changing means. The fluid path 71 is formed between the second electromagnetic valve 20 and the advanced angle chamber of the exhaust valve phase changing means, and the fluid path 72 is formed between the second electromagnetic valve 20 and the retarded angle chamber of the exhaust valve phase changing means.

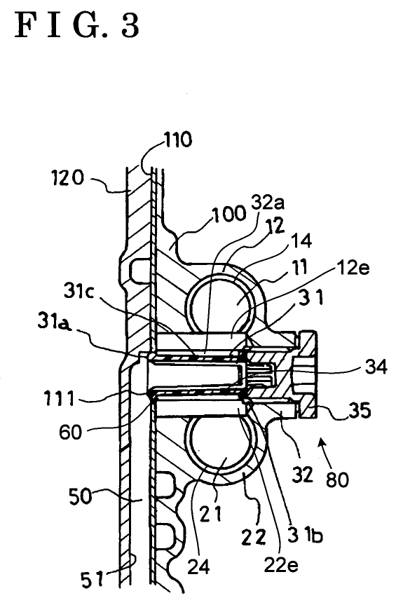

As shown in FIG. 3, a plate 120 is fixed to the timing chain cover 100 by means of a fixing member 121 (shown in FIG. 2) in a manner where a gasket 110 is sandwiched between the plate 120 and the timing chain cover 100. Further, a groove 51 is formed on the plate 120, and an opening of the groove 51 is sealed by means of the gasket 110 so as to form a fluid path 50.

Similarly, a groove 61a formed on the timing chain cover 100 is sealed by means of the gasket 110 so as to form the fluid path 61, and a groove 62a formed on the gasket 110 is sealed by means of the gasket 110 so as to form the fluid path 62.

Further, a groove 71a formed on the timing chain cover 100 is sealed by means of the gasket 110 so as to form the fluid path 71, and a groove 72a formed on the gasket 110 is sealed by means of the gasket 110 so as to form the fluid path 72.

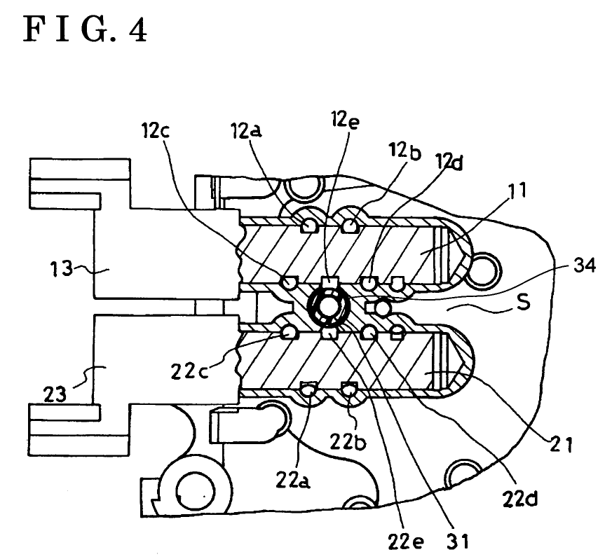

As shown in FIGS. 3 and 4, the first electromagnetic valve 10 includes a spool 11 serving as a first valve unit, a first valve unit housing space 14 for housing the spool 11, a sleeve 12 serving as a first housing portion and forming the first valve unit housing space 14, and a solenoid 13 for actuating the spool 11. The second electromagnetic valve 20 includes a spool 21 serving as a second valve unit, a second valve unit housing space 24 for housing the spool 21, a sleeve 22 serving as a second housing portion and forming the second valve unit housing space 24, and a solenoid 23 for actuating the spool 21. The spool 11 is movably housed in the sleeve 12, and the spool 21 is movably housed in the sleeve 22. In this embodiment, the first housing portion may be integrated with the second housing portion. Thus, the number of parts can be decreased, and the electromagnetic valve unit can be downsized.

The oil filter 30 is comprised of a filtering member 31, a space within a cylinder 32a serving as a housing space in which the filtering member 31 is housed, and a case portion 32 forming the housing space. On one end of the case portion 32, a plug 35 is fit so as to fix the filtering member 31 in the case portion 32. The filtering member 31 is formed in a cylinder shape having a bottom portion 31b. An opening end portion 31a of the filtering member 31 is positioned within the through hole 111 formed on the gasket 110 so as to be fixed thereto. A bottom portion 31b contacts with the plug 35 so as to be fixed.

The cylinder portion 31c of the filtering member 31 is formed in a mesh-type shape. The space within a cylinder 32a is formed so as to penetrate through the case portion 32, and one end of the space within a cylinder 32a is closed by means of a plug 35, which is fit to the case portion 32. In this configuration, the filtering member 31 housed in the space within a cylinder 32a can be replaced after removing the plug 35 from the case portion 32. Thus, the filtering member can be easily replaced; as a result maintenance efficiency has been impaired. Further, in this embodiment, the first housing portion may be integrated with the second housing portion. Thus, the number of parts can be decreased, and the electromagnetic valve unit can be downsized.

As shown in FIG. 4, on the upper side of the sleeve 12 of the first electromagnetic valve 10, an advanced angle supply port 12a and a retarded angle supply port 12b are formed. Specifically, the advanced angle supply port 12a opens to the fluid path 61, which is connected to the advanced angle chamber, and the retarded angle supply port 12b opens to fluid path 62, witch is connected to the retarded angle chamber. On the lower side of the sleeve 12, an advanced angle drain port 12c and a retarded angle drain port 12d are formed. Specifically, the hydraulic oil drains from the advanced angle chamber, through the fluid path 61, to the advanced angle drain port 12c, and the hydraulic oil drains from the retarded angle chamber, through the fluid path 62, to the retarded angle drain port 12d.

On the other hand, on the lower side of the sleeve 22 of the second electromagnetic valve 20, an advanced angle supply port 22a and a retarded angle supply port 22b are formed. Specifically, the advanced angle supply port 22a opens to the fluid path 71, which is connected to the advanced angle chamber, and the retarded angle supply port 22b opens to fluid path 72, witch is connected to the retarded angle chamber. On the upper side of the sleeve 22, an advanced angle drain port 22c and a retarded angle drain port 22d are formed. Specifically, the hydraulic oil drains from the advanced angle chamber, through the fluid path 71, to the advanced angle drain port 22c, and the hydraulic oil drains from the retarded angle chamber, through the fluid path 72, to the retarded angle drain port 22d.

Between the drain port 12c and the drain port 12d of the first electromagnetic valve 10, a first supply port 12e, to which the hydraulic oil is supplied from the oil pump 40 through the fluid path 50, is formed. On the other hand, between the drain port 22c and the drain port 22d of the second electromagnetic valve 20, a second supply port 22e, to which the hydraulic oil is supplied from the oil pump 40 through the fluid path 50, is formed.

The space within a cylinder 32a is formed integrally with the first supply port 12e and the second supply portion 22e so as to form a space, which exist among the sleeve 12, the sleeve 22 and the case portion 32. In other words, the first supply port 12e and the second supply port 22e are formed by the space within a cylinder 32a. Because the space within a cylinder 32a, the first supply port 12e and the second supply port 22e are integrally formed, the space within a cylinder 32a can be directly connected to the first supply port 12e and the second supply port 22e. Thus, there is no need to form additional fluid paths between the space within a cylinder 32a and the supply port 12e, and between the space within a cylinder 32a and the supply port 22e, as a result, the electromagnetic valve unit can be downsized.

Further, in the first embodiment, the first valve unit housing space 14 is connected to the second valve unit housing space 24 by means of the first supply port 12e, the space within a cylinder 32a and the second supply port 22e.

In this circumstances, the first valve unit housing space 14, the second valve unit housing space 24, the first supply port 12e, the space within a cylinder 32a and the second supply port 22e are formed integrally with the sleeve 12, the sleeve 22 and the case portion 32, as a result, the electromagnetic valve unit can be downsized.

As shown in FIG. 4, because a diameter of each of the solenoid 13 and the solenoid 23, which is comprised of a coil portion to which a coil is wound, is larger than a diameter of each of the sleeve 12 and the sleeve 22, a space S is formed between the sleeve 12 and the sleeve 22 when the electromagnetic valve 10 is provided next to the electromagnetic valve 20. Because the filter 30 is provided in the space S formed between the sleeve 12 and the sleeve 22, there is no need to provide an additional space for the filter 30, as a result, the timing chain cover 100, furthermore the engine can be downsized.

Further, when the timing chain cover 100 is formed by die-cast, a portion of the timing chain cover 100, which corresponds to the space S, generally becomes thick, and such thick portion is intensively heated. However, in this embodiment, because the space within a cylinder 32a of the filter 30 is provided in the space S, casting porosities caused by such thickness and such intensive heat cannot be formed, or can be removed.

Furthermore, as shown in FIG. 3, the sleeve 12, the sleeve 22 and the case portion 32 are integrally formed so as to configure the housing 80 as a unit. An opening portion 60 connected to the oil pump 40 is formed on the housing 80, and the space within a cylinder 32a serving as the housing space for the filtering member 31 is connected to the opening portion 60. Further, because the first supply port 12e and the second supply port 22e are connected to the space within a cylinder 32a, the first supply port 12e and the second supply port 22e are connected to the opening portion 60 by means of the space within a cylinder 32a.

In this circumstances, when the opening portion 60 formed at the housing 80 is connected to the oil pump 40, the hydraulic oil is supplied from the first supply port 12e to the first electromagnetic valve 10, and the hydraulic oil is supplied from the second supply port 22e to the second electromagnetic valve 20.

Thus, even when two electromagnetic valves are provided, there is no need to form two fluid paths between the oil pump 40 and the opening portion 60, and only one fluid path is formed between the oil pump 40 and the opening portion 60, as a result, a process for forming the fluid path can be simplified.

Further, in this embodiment, as shown in FIG. 3, the sleeves 12 and 22, the case portion 32 and the timing chain cover 100 are integrally formed. Thus, the number of parts, as an engine cover unit, can be reduced. Further, the opening portion 60, the space within a cylinder 32a, the first and the second supply ports 12e and 22e and the first and the second valve unit housing spaces 14 and 24 can be formed integrally with the housing, which is comprised of the timing chain cover 100. In this case, the costs for forming each space can be reduced as a whole.

Next, an actuation of the first embodiment will be explained. After the engine is started, and when opening/closing timings of the intake valve and the exhaust valve need to be changed depending on an engine rotation number and an engine load, rotation phases of the intake valve camshaft and the exhaust valve camshaft are changed. When the rotation phases of the intake valve camshaft and the exhaust valve camshaft are changed, the hydraulic oil is supplied to the first electromagnetic valve 10 and the second electromagnetic valve 20 from the oil pump 40 through the fluid path 50. By an actuation of the first electromagnetic valve 10, the hydraulic oil is selectively supplied to either one of the advanced angle chamber and the retarded angle chamber of the intake valve phase changing means. On the other hand, by an actuation of the second electromagnetic valve 20, the hydraulic oil is selectively supplied to either one of the advanced angle chamber and the retarded angle chamber of the exhaust valve phase changing means. Thus, the opening/closing timings of the intake valve and the exhaust valve are preferably controlled. In this circumstance, because the electromagnetic valve 10 is positioned next to the electromagnetic valve 20, and the oil filter 30 is provided between the electromagnetic valve 10 and the electromagnetic valve 20, a length of the fluid path between the electromagnetic valve 10 and the intake valve phase changing means and a length of the fluid path between the electromagnetic valve 20 and the exhaust valve phase changing means can be shortened, as a result, the opening/closing timings of the intake valve and the exhaust valve can be rapidly changed.

Further, because the oil filter 30 is provided at the timing chain cover 100, the filtering member 31 can be easily replaced, as a result, maintenance efficiency has been impaired.

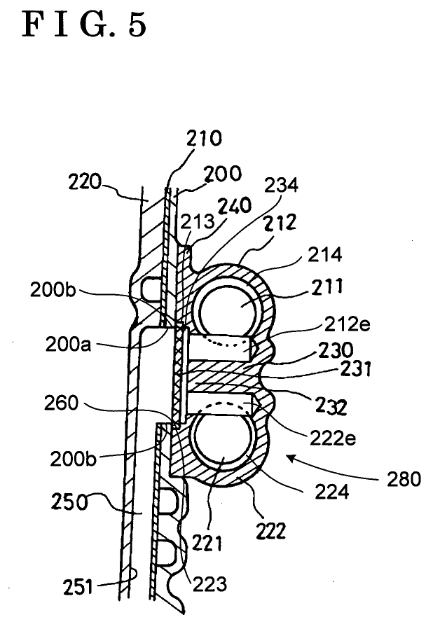

A second embodiment according to the present invention will be explained with reference to FIG. 5. As shown in FIG. 5, a sleeve 212 serving as a first housing portion and a sleeve 222 serving as a second housing portion are integrally formed so as to form a housing 280. The housing 280 is detachably fixed to the timing chain cover 200 by means of a fixing member (not shown), and this structure is different from the structure of the electromagnetic valve unit described in the first embodiment.

Specifically, in the second embodiment, the housing 280 forms a housing of the electromagnetic valve unit. Further, In the same manner as the electromagnetic valve unit described in the first embodiment, a first valve unit housing space 214, which houses a spool 211 serving as a first valve unit, is formed at the sleeve 212, and a second valve unit housing space 224, which houses a spool 221 serving as a second valve unit, is formed at the sleeve 222.

A first supply portion 212e is formed at the sleeve 212, and a second supply port 222e is formed at the sleeve 222. An opening portion 260 is formed at the housing 280 so as to connect to the oil pump 40, and a housing space 234 for housing a filtering member 231 is formed at the housing 280 so as to connect to the opening portion 260. Specifically, the opening portion 260 is formed by forming a recessed portion at the housing 280, and such recessed portion serves as the housing space 234 in which the filtering member 231 is housed. Further, the recessed portion includes stepped portions 213 and 223 in order to regulate the position of the filtering member 231. On the other hand, at the timing chain cover 200, an opening portion 200a is formed so as to connect to the oil pump 40 (not shown in FIG. 5). The housing 280 contacts with the timing chain cover 200 in a manner where the opening portion 260 of the housing 280 is aligned with the opening portion 200a of the timing chain cover 200. In addition, a flange portion 200b is formed at the opening portion 200a so that the opening 200a becomes smaller than the opening portion 260, and thus, when the housing 280 contacts with the timing chain cover 200, the filtering member 231 is sandwiched between the flange portion 200b and the stepped portions 213 and 223, as a result, the filtering member 231 can be fixed within the housing space 234. A groove 251 formed on the plate 220 is sealed by means of the gasket 210 so as to form a fluid path 250, and the spool 211 is housed in the sleeve 212, and the spool 221 is housed in the sleeve 222 so as to be movable.

In this configuration, in the same manner as the first embodiment, because each of the first supply port 212e and the second supply port 222e is connected to the opening portion 260 through the housing space 234, hydraulic oil can be respectively supplied to the first electromagnetic valve 210 and the second electromagnetic valve 220 from the first supply portion 212e and the second supply port 222d through the opening portion 260, which is formed on the housing 280 and connected to the oil pump 40. Thus, even when two electromagnetic valves are provided, there is no need to form two fluid paths between the oil pump 40 and the opening portion 260, as a result, a process for forming the fluid path can be simplified. Further, only one opening such as the opening portion 200a, which corresponds to the opening portion 260 of the electromagnetic valve unit, needs to be formed, as a result, a process for forming the timing chain cover 200 can be simplified.

Further, because the housing 280 is detachably fixed to the timing chain cover 200, and the filtering member 231 is positioned between the housing 280 and the timing chain cover 200, the filtering member 231 can be easily replaced after removing the housing 280 from the timing chain cover 200.

The present invention is not limited to only the electromagnetic valve units described in the first embodiment and the second embodiment. For example in the embodiments, the valve opening/closing timing control device is explained as an example of the first and the second hydraulic mechanisms, however, another hydraulic mechanisms can be applied alternatively. Thus, the present invention can be preferably applied to the electromagnetic valve unit having plural electromagnetic valves for independently controlling the amount of the hydraulic oil supplied to plural hydraulic mechanisms. And the present invention can also be preferably applied to an engine cover unit, in which an electromagnetic valve unit is formed integrally with such as an engine cover (e.g., a timing chain cover, a cylinder head cover and a cylinder head).

The cover provided at the end portion of the engine serves as at least one portion of an engine case. Specifically, a timing chain cover, a cylinder head cover and a cylinder head can be presented as examples of such cover (hereinafter referred to as an engine cover type). Thus, the engine cover unit according to the present invention includes the engine cover type to which an electromagnetic valve unit and an oil filter are fixed.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the sprit of the present invention. Accordingly, it is expressly intended that all such variations, changes and equivalents which fall within the spirit and scope of the present invention as defined in the claims, be embraced thereby.

1. An electromagnetic valve unit comprising:
a first electromagnetic valve provided at a cover, which is positioned at one end portion of an engine, for controlling an amount of hydraulic oil supplied from a hydraulic pressure source to a first hydraulic mechanism;
a second electromagnetic valve provided at the cover so as to be next to the first electromagnetic valve for controlling an amount of hydraulic oil supplied from the hydraulic pressure source to a second hydraulic mechanism; and
an oil filter provided between the first electromagnetic valve and the second electromagnetic valve and connected to each of the first and the second electromagnetic valves in order to filter the hydraulic oil supplied to each of the first and the second electromagnetic valves.

2. The electromagnetic valve unit according to claim 1, wherein the first electromagnetic valve includes a first valve unit and a first housing portion in which the first valve unit is housed, the second electromagnetic valve includes a second valve unit and a second housing portion in which the second valve unit is housed, the oil filter includes a filtering member and a case portion in which the filtering member is housed, and the first housing portion is connected to the second housing portion by means of the case portion.

3. The electromagnetic valve unit according to claim 2, wherein the first housing portion includes a first supply port to which the hydraulic oil is supplied from the hydraulic pressure source, the second housing portion includes a second supply port to which the hydraulic oil is supplied from the hydraulic pressure source, the case portion includes a housing space in which the filtering member is housed, and the first and the second supply ports and the housing space is integrally formed.

4. The electromagnetic valve unit according to claim 3, wherein a first valve unit housing space for housing the first valve unit is formed at the first housing portion, a second valve unit housing space for housing the second valve unit is formed at the second housing portion, and the first valve unit housing space is connected to the second valve unit housing space by means of the first supply port, the housing space, and the second supply port.

5. The electromagnetic valve unit according to claim 2, wherein the first housing portion, the second housing portion and the case portion are integrally formed so as to form a housing as a unit.

6. The electromagnetic valve unit according to claim 3, wherein the first housing portion, the second housing portion and the case portion are integrally formed so as to form a housing as a unit.

7. The electromagnetic valve unit according to ° claim 6, wherein an opening portion connected to the hydraulic pressure source is formed at the housing, the housing space is connected to the opening portion, and the each of the first and the second supply port is connected to the opening portion through the housing space.

8. The electromagnetic valve unit according to claim 5, wherein the housing and the cover are integrally formed.

9. The electromagnetic valve unit according to claim 7, wherein the housing and the cover are integrally formed.

10. The electromagnetic valve unit according to claim 1, wherein the first hydraulic mechanism is an intake valve opening/closing timing control device for changing a rotation phase of the intake valve camshaft, and the second hydraulic mechanism is an exhaust valve opening/closing timing control device for changing a rotation phase of an exhaust valve camshaft.

11. An engine cover unit comprising:
a cover provided at an end portion of an engine;
a first electromagnetic valve provided at the cover for controlling an amount of hydraulic oil supplied from a hydraulic pressure source to a first hydraulic mechanism;
a second electromagnetic valve provided next to the first electromagnetic valve for controlling an amount of hydraulic oil supplied from the hydraulic pressure source to a second hydraulic mechanism; and
an oil filter provided between the first electromagnetic valve and the second electromagnetic valve and connected to each of the first and the second electromagnetic valves in order to filter the hydraulic oil supplied to each of the first and the second electromagnetic valves.

12. The engine cover unit according to claim 11, wherein the first electromagnetic valve includes a first valve unit and a first housing portion in which the first valve unit is housed, the second electromagnetic valve includes a second valve unit and a second housing portion in which the second valve unit is housed, the oil filter includes a filtering member and a case portion in which the filtering member is housed, and the first housing portion is connected to the second housing portion by means of the case portion.

13. The engine cover unit according to claim 12, wherein the first housing portion includes a first supply port to which the hydraulic oil is supplied from the hydraulic pressure source, the second housing portion includes a second supply port to which the hydraulic oil is supplied from the hydraulic pressure source, the case portion includes a housing space in which the filtering member is housed, and the first and the second supply ports and the housing space is integrally formed.

14. The engine cover unit according to claim 13, wherein a first valve unit housing space for housing the first valve unit is formed at the first housing portion, a second valve unit housing space for housing the second valve unit is formed at the second housing portion, and the first valve unit housing space is connected to the second valve unit housing space by means of the first supply port, the housing space, and the second supply port.

15. The engine cover unit according to claim 12, wherein the first housing portion, the second housing portion and the case portion are integrally formed so as to form a housing as a unit.

16. The engine cover unit according to claim 13, wherein the first housing portion, the second housing portion and the case portion are integrally formed so as to form a housing as a unit.

17. The engine cover unit according to claim 16, wherein an opening portion connected to the hydraulic pressure source is formed at the housing, the housing space is connected to the opening portion, and the each of the first and the second supply port is connected to the opening portion through the housing space.

18. The engine cover unit according to claim 15, wherein the housing and the cover are integrally formed.

19. The engine cover unit according to claim 17, wherein the housing and the cover are integrally formed.

20. The engine cover unit according to claim 11, wherein the first hydraulic mechanism is an intake valve opening/closing timing control device for changing a rotation phase of the intake valve camshaft, and the second hydraulic mechanism is an exhaust valve opening/closing timing control device for changing a rotation phase of an exhaust valve camshaft.
